(19) United States
(12) Patent Application Publication
(10) Pub. No.: US 2019/0351697 A1
(43) Pub. Date: Nov. 21, 2019

(54) PAINT CAN CADDIE

(71) Applicant: Lowell Hughes, Lithia Springs, GA (US)

(72) Inventor: Lowell Hughes, Lithia Springs, GA (US)

(21) Appl. No.: 15/984,778

(22) Filed: May 21, 2018

(51) Int. Cl. B44D 3/12; B44D 3/14

(52) U.S. Cl. CPC B44D 3/128; B44D 3/14

(57) ABSTRACT

A paint can caddie, including a can receiving portion to receive a base and at least a portion of an outer circumference of a paint can therein, and a paint storing portion circumferentially disposed around the can receiving portion to receive paint spilled from the paint can.

### BACKGROUND

### 1. Field

The present general inventive concept relates generally to paint can caddie

### 2. Description of the Related Art

Painting is an exciting job, but is often laborious given the fact that paint-spills are quite common. This is especially true for people who paint their homes themselves and are often forced to use hundreds of newspapers or other materials as a covering for the floor. However, even if a floor is covered with newspapers or other materials, spilled paint may still seep through and cause stains to the floor.

Therefore, there is a need for device that prevents paint from spilling from a paint can onto a floor.

### SUMMARY

The present general inventive concept provides a paint can caddie.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a paint can caddy, including a can receiving portion to receive a base and at least a portion of an outer circumference of a paint can therein, and a paint storing portion circumferentially disposed around the can receiving portion to receive paint spilled from the paint can.

The can receiving portion may have a circular shape to fit the paint can therein.

The paint can caddy may further include a lid removably attached to a top portion of the paint storing portion.

The lid may include a removed portion disposed to be distanced away from a top edge of the paint storing portion to allow the paint to enter the paint storing portion even if the lid is attached to the top portion of the paint storing portion.

The paint storing portion may include an inner wall disposed next to a wall of the can receiving portion, an outer wall disposed around and distanced from the inner wall, and a base disposed at a bottom portion of the paint storing portion to connect the inner wall to the outer wall.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a top angled view of a paint can disposed within a paint can caddy, according to an exemplary embodiment of the present general inventive concept; and

FIG. 2 illustrates a cross-sectional side view of the paint can disposed within the paint can caddy, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

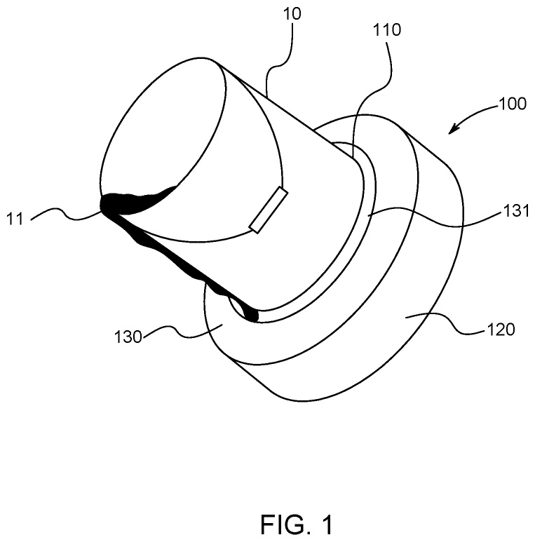

FIG. 1 illustrates a top angled view of a paint can 10 disposed within a paint can caddie 100, according to an exemplary embodiment of the present general inventive concept.

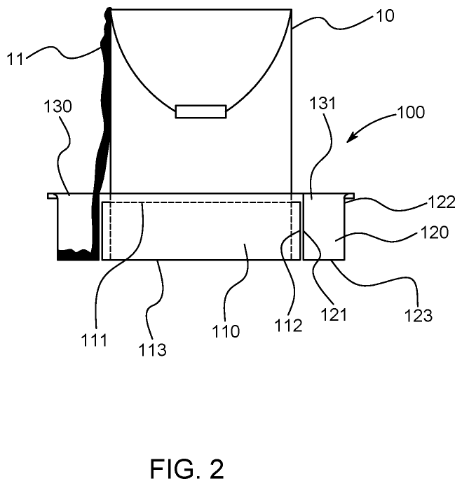

FIG. 2 illustrates a cross-sectional side view of the paint can 10 disposed within the paint can caddie 100, according to an exemplary embodiment of the present general inventive concept.

The paint can caddie 100 (a.k.a., “paint can caddy 100”) may have a circular shape, but is not limited thereto, and can any shape known to one of ordinary skill in the art.

The paint can caddy 100 may have any size to allow the paint can 10 to be held snugly therewithin, such that the paint can caddy 100 may have any size to correspond to any size of the paint can 10.

The paint can caddy 100 may be constructed from plastic, metal, cloth, rubber, silicone, latex, wood, etc., but is not limited thereto.

The paint can caddy 100 may include a can receiving portion 110, a paint storing portion 120, and a lid 130.

Referring to FIGS. 1 and 2, the paint can 10 may be inserted into the can receiving portion 110 such that paint can 10 fits snugly into the can receiving portion 110.

The can receiving portion 110 may act as a base, such that a base of the paint can 10 may fit into the can receiving portion 110. As stated above, the can receiving portion 110 may have various sizes to allow various sizes of the paint can 10 to be fit thereinto.

The can receiving portion 110 may have a tape portion 111 disposed around an inner circumference of the can receiving portion 110, such that the paint can 10 may be snugly attached within the can receiving portion 110. The tape portion 111 may be constructed from rubber, silicon, or any other material to allow the paint can 10 to be removably adhered to an inner portion of the can receiving portion 110.

The can receiving portion 110 may have a wall 112 circumferentially disposed in a circle, and a base 113.

The paint storing portion 120 may be disposed around an outer circumference of the can receiving portion 110, such that paint 11 leaking down the paint can 10 may caught and stored by the paint storing portion 120. In other words, the paint storing portion 120 may include an inner wall 121, an outer wall 122, and a base 123.

The inner wall 121 may be disposed next to the wall 112 of the can receiving portion 110. The outer wall 122 may be disposed around and distanced from the inner wall 121. The base 123 may be disposed at a bottom portion of the paint storing portion 120 to connect the inner wall 121 to the outer wall 122.

The removable lid 130 may be optionally removable, and may be constructed to fit over the paint storing portion 120, and may have a removed portion 131 to allow the paint 11 to seep inside the paint storing portion 120 even if the removable lid 130 is disposed on the paint storing portion 120.

More specifically, the removed portion 131 may be disposed to be distanced away from a top edge of the paint storing portion 120 to allow the paint 11 to enter the paint storing portion 120 even if the removable lid 130 is attached to the top portion of the paint storing portion 120.

As illustrated in FIGS. 1 and 2, the paint can 10 may be inserted into the can receiving portion 110, such that outer circumferential walls of the can receiving portion 110 contact an outer surface of the paint can 10, such that the paint storing portion 120 may receive the paint 11 spilled out (i.e., leaked out) from the paint can 10.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A paint can caddy, comprising:
a can receiving portion to receive a base and at least a portion of an outer circumference of a paint can therein, the can receiving portion comprising:
a wall circumferentially disposed in a circle, such that the wall covers at least a portion of the paint can; and
a paint storing portion circumferentially disposed around the can receiving portion to receive paint spilled from the paint can.

2. The paint can caddy of claim 1, wherein the can receiving portion has a circular shape to fit the paint can therein.

3. The paint can caddy of claim 1, further comprising:
a lid removably attached to a top portion of the paint storing portion.

4. The paint can caddy of claim 3, wherein the lid comprises a removed portion disposed to be distanced away from a top edge of the paint storing portion to allow the paint to enter the paint storing portion even if the lid is attached to the top portion of the paint storing portion.

5. The paint can caddy of claim 1, wherein the paint storing portion comprises:
an inner wall disposed next to the wall of the can receiving portion;
an outer wall disposed around and distanced from the inner wall; and
a base disposed at a bottom portion of the paint storing portion to connect the inner wall to the outer wall.
